(19) United States
(12) Patent Application Publication
(10) Pub. No.: US 2016/0318283 A1
(43) Pub. Date: Nov. 3, 2016

(54) Metal Integrated Plastic Composite

(71) Applicant: Sonim Technologies(Shenzhen) Ltd, Guangdong (CN)

(72) Inventors: Liu Liu, Beijing (CN); Tianjiao Dai, Beijing (CN)

(73) Assignee: Sonim Technologies(Shenzhen) Ltd, Guangdong (CN)

(21) Appl. No.: 14/984,904

(22) Filed: Dec. 30, 2015

(30) Foreign Application Priority Data
Apr. 30, 2015 (CN) 2015102195935

(51) Int. Cl. B32B 15/088; B29C 45/14; B32B 5/18

(52) U.S. Cl. CPC B32B 15/088; B32B 5/18; B29C 45/14311; B32B 2250/02; B32B 2260/02; B32B 2260/046; B32B 2266/045; B32B 2307/3065; B29C 2045/14868; B29K 2071/00

(57) ABSTRACT

A composite and methods of preparing the composite. The method includes treating a surface of a metallic substrate, where the metallic substrate includes a single element metal or an alloy, to obtain a nanoporous structure. The method further includes interlocking the nanoporous structure with plastic, wherein the plastic is composed of at least one layer of Polyether Block Amide (PEBA) to obtain the composite.

### TECHNICAL FIELD

The present invention relates to plastic, and particularly, relates to a composite comprising the plastic integrated with a metallic substrate. This application claims the benefit of Chinese Application 2015102195935, filed on Apr. 30, 2015.

### BACKGROUND OF THE INVENTION

Metals and plastic are treated to change their surface properties to form metal integrated plastic composites, herein referred to as a composite. This is generally performed in order to retain the properties of plastic, such as plasticity/flexibility, and also impart properties of metal, such as metal strength. In addition, these composites are associated with a high tensile strength, and hence find wide applications in automotive, household electrification, personal commodity to provide waterproof and dustproof properties.

Conventionally, the plastic and the metal are integrated by using an adhesive. Newer methods are now emerging for integration of the metal with the plastic. For example, Chinese patent CN200780047587 discloses a composite where a Titanium (Ti) alloy was surface treated and insert is injected into a kind of thermal plastic to improve the bonding force. This composite is widely used in portable electronic devices, home appliance, healthcare equipment, automotive contracture components, vehicle-mounted device, other electrical components, and anti-corrosion outer parts.

One critical parameter that influences the application of the composite is the bonding force. The bonding force is dependent on the selection of plastic, metal and the integration process. For instance, bonding a Ti alloy with a plastic composed of polyphenylene sulfide shows markedly different bonding force properties as compared to use of a plastic composed of polybutylene terapthalate.

The above information is presented as background information only to help the reader to understand the present invention. Applicants have made no determination and make no assertion as to whether any of the above might be applicable as Prior Art with regard to the present application.

### SUMMARY

The principal object of the embodiments herein is to integrate a metallic substrate and a plastic to form a metal integrated plastic composite.

Another object of the embodiments herein is to develop a process to integrate the metal and the plastic to form the metal integrated plastic composite.

Another object of the embodiments herein is to develop the metal integrated plastic composite with a bonding force requirement correlating to the application.

Accordingly the embodiments herein provided relate to a metal integrated plastic composite, and a process of preparing the same. The metal integrated plastic composite is herein referred to as a composite. The composite includes plastic interlocked to a surface of the metallic substrate.

In an embodiment, the metallic substrate includes a single element metal or an alloy.

In an embodiment, the single element metal is one of Aluminum, Magnesium, Titanium, Copper, and Stainless steel.

In yet another embodiment, at least a portion of the metallic substrate is chemically treated to obtain a nano-porous structure.

In another embodiment, the nano-porous structure comprises of pores having a diameter in a range of 10 to 2000 nanometers (nm).

In another embodiment, the nanoporous structure is obtained by anodic oxidation.

In an embodiment, the plastic is composed of one or more layers of

Polyether Block Amide (PEBA). In an embodiment, the PEBA is copolymer of an amide and an ether, where the amide has a weight percentage of at least 10%, more preferably in a range of 30% to 90%.

In an embodiment, the PEBA is of a molecular weight ranging from 500-20000 g/mol.

In an embodiment, the composite has one or more of flame retardant, impact resistance, seal performance, and reinforcing agent property. The polymer or plastics can be modified to impart flame retardant, impact resistance, seal performance, and reinforcing agent property.

The present invention also relates to a process for preparing the composite. The process includes treating a surface of a metallic substrate to obtain a nanoporous structure. In an embodiment, the metallic substrate includes a single element metal or an alloy.

In an embodiment, the nanoporous structure comprises of pores having a diameter in a range of 10 to 2000 nanometers (nm).

In an embodiment, the nanoporous structure is obtained by anodic oxidation.

The process further comprises interlocking the nanoporous structure with a plastic. In an embodiment, the plastic is composed of one or more layers of Polyether Block Amide (PEBA), to obtain the composite.

In an embodiment, the amide component in PEBA has a weight percentage of at least 10%, more preferably in a range of 30% to 90%.

In an embodiment, PEBA is of a molecular weight ranging from 500-20000 g/mol.

In an embodiment, the interlocking is performed by injecting, at least once, the plastic into the nanoporous structure under optimum conditions.

In an embodiment, the optimum conditions include an injection temperature in a range of 210-270° C., injection pressure in an range of range of 8 to 11 MPa, mold temperature in a range of range of 40-80° C., and a cooling speed being controlled at a rate of 6-8° C./second.

The process further comprises immersing the composite in water at a temperature range of 40-80° C. for 8-12 hours.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 illustrates an example of a composite where a portion of a metal is integrated with Polyether Block Amide (PEBA) by injection molding process, according to an embodiment as disclosed herein;

FIG. 2 illustrates an example of multi-layer composite formed by integrating the metal with the PEBA or/and plastics composed on several layers, according to an embodiment as disclosed herein; and

FIG. 3 illustrates an example where metal is integrated with two different polymer, where one of the two is PEBA, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The metallic substrate may be interchangeably used as metal throughout the draft.

Accordingly, the embodiments herein provided relate to metal integrated plastic composites, the methods of manufacturing the same, and its applications thereof.

This invention relates to a composite of a metallic substrate. The metallic substrate may be a single element metal or an alloy. The single element metal can be one of aluminum, magnesium, titanium, copper, and stainless steel. The metallic substrate is chemically treated to obtain a karst cave like nano-porous structure. In an embodiment, the nano-porous structure comprises of pores having a diameter in a range of 10 to 2000 nanometers (nm). In an embodiment, the nanoporous structure is obtained by anodic oxidation to generate etched pores on anodized oxidation film. The diameter of the nanometer size pores, also referred as nanopores, range 10-100 nm and the diameter of the etched nanopores on the anodized oxidation film are 100-2000 nm.

The composite further comprises plastic composed of one or more layers of PEBA. In an embodiment, the plastic is an elastomer/rubber. The molecular formula of is represented as HO—(CO-PA-CO-PE-O)n-H. PA stands for polyamide unit (called as Nylon) and PE stands for polyether. It means the PEBA is a copolymer that polyether unit block amide unit. The stiffness of PA and flexibility of PE are showed in the PEBA. It's a 2-phase structure which includes thermal plastic (the crystal phase) and elastomer (amorphous phase). It is considered as adhesive of congeneric composite due to the special structure but it isn't recommended due to low mechanical strength and high water absorption. In an embodiment, the amide has a weight percentage of at least 10%, more preferably in a range of 30% to 90%. In an embodiment, the PEBA is of a molecular weight ranging from 500-20000 g/mol.

PEBA in this example is commercialized industrial product. We can select proper polyamide unit percentage PEBA to meet the hardness requirement. In real cases, the polyamide unit can be PA6, PA66, PA12, PA11, PA6/11, PA6/12, PA610, and PA1010. All the PEBA can be purchased from the market or compounded as requirements.

PEBA that is used shall integrate with the metal to form the composite. The plastic interlocks at this area, i.e., within the nano-porous structure to form a composite with good binding force. Plastic can not only integrate with metal closely, the composite also can solve the seal issue with the soft part when it is assembled with other parts or connected with other material. For example, the plastic integrates with the metal closely when the composites are the front cover and back cover. At the same time, the parts can be assembled with soft or hard interfaces without a 3^{rd} material (such as an adhesive or O ring) where the elastomer and metal are the junction surfaces. The seal performance improves, assembling material and process complexity reduces, the cost reduces and the quality is controlled better.

The composite of this invention where at least a portion of the metal integrates with the plastic where PEBA is the main component. The composite can assemble parts of instruments and equipment's. The shape and structure of the composite can be obtained from the metal pre-treatment, plastic injection into the mold tool and further processing. The composite can also be applied where high precisions and high tightness is required, such as EMI and insulation products, such as shielding like products

The present invention also relates to a method for manufacturing the composite.

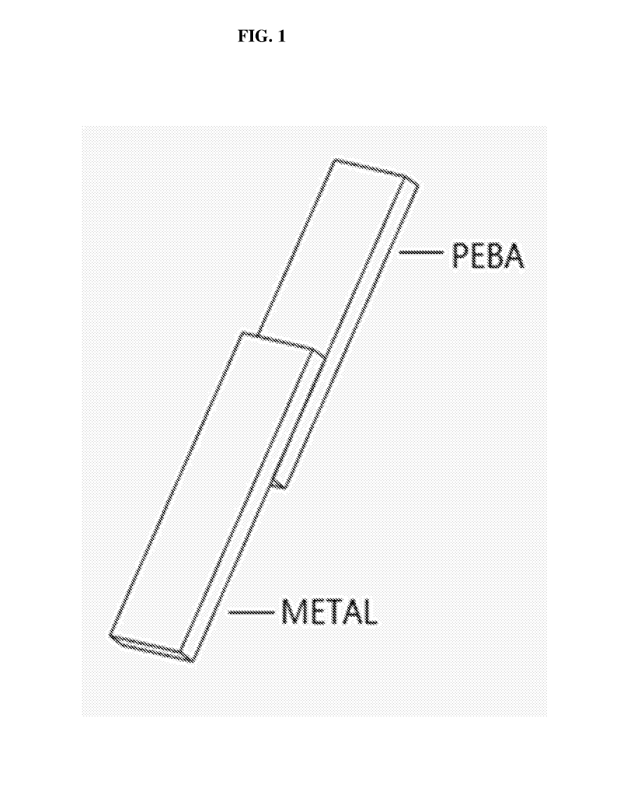

FIG. 1 illustrates an example of a composite where a portion of a metal is integrated with Polyether Block Amide (PEBA) by injection molding process, according to an embodiment as disclosed herein.

For this purpose, a surface of a metallic substrate, also referred to as metal in the draft, is chemically treated to form nanometer size porous structure (or called as concave-convex structure), herein referred to as the nanoporous structure to obtain a nano-porous structure. The chemical treatment is normal treatment or treatments reported in the art. For example, at least a portion of the metal is etched by acid/alkali to form nanometer size pores. Alternatively, at least a portion of the metal is treated by a combined process of anode oxidation and chemical etching processing to form three-dimensional nanometer concave-convex structure through formation of oxidized film on the surface of the metal. The nanometer concave-convex looks like porous structure with thousands of pores. The pore size is 10-2000 nm

In one manufacturing method, the mentioned chemically treatment include the anodizing oxidation in at least part of metal surface to form the film with nanometer pores whose diameter is in a range of10-100 nm. Further, the part of the metal is chemically etched to form nanometer pores whose diameter is 100-2000 nm.

Yet another object of the invention is to obtain nanometer or chemically etched micro-pores could be any public reported treatment or processing. For example, an anodized and chemical treatment reported in CN103290449A can be used to form nanometer pores.

The nano-porous structure thus obtained is put in an injection mold tool. Further, the plastic is injected into the injection molding tool for interlocking the metallic substrate with the plastic.

In an embodiment, the interlocking is carried out by injecting the plastic under optimum conditions. In an embodiment, the optimum conditions include an injection temperature is 210-270° C., injection pressure ranging from 8-11MPa, and tooling temperature ranging from 40-80° C. More specifically, the plastic melt temperature is controlled as 230-250° C., the tooling temperature is controlled as 50-60° C., then cooled to obtain the mentioned composite. The plastic is molded in the injection molding tool, and further cooled and processed at a cooling temperature speed ranging from 6-8° C./second. Cooling the molded part as soon as possible by any methods as disclosed in the art can help to obtain expected crystal effect. For example, press cold water is used to speed up the cooling process.

In an embodiment, the composite treated with hot water shows better bonding performance. In an embodiment, the temperature of the water is maintained at 40-80° C., for 8 to12 hours. Also, the bonding performance and other properties can be improved through adjustment of the raw material ratio (such as the PA content in PEBA) and the choice of process parameter. There are 2 ways to evaluate the bonding force. The force to separate the PEBA and metal is greater, greater is the bonding force. Also, if after separating the metal and PEBA, more PEBA left on metal, the bonding force is considered even greater.

In an embodiment, the injection process include all kinds of molding process which can include, but not limited to, injection, extrusion, blowing molding or dip etc.

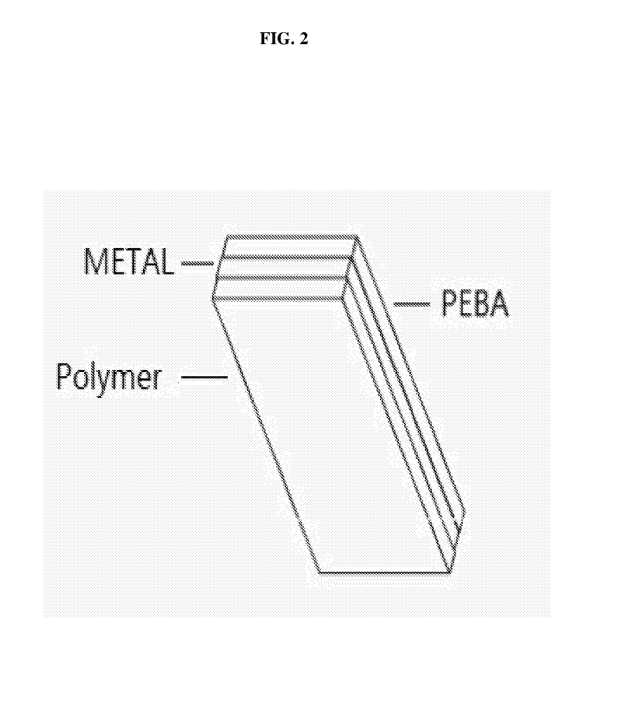

FIG. 2 illustrates an example of multi-layer composite formed by integrating the metal with the PEBA composed on several layers, according to an embodiment as disclosed herein. In an embodiment, the number of times the plastic is injected into the injection mold co-relates to the number of layers in the composite. For example, the composite can be multi-layer with twice-injection or multi-injection to form the shape and structure. Considering no impact on the injection result, the composite can be multi-layer with different figure or shape, and color. The color can be incorporated by adding different color pigment or characteristics additives (such as an appropriate amount of particles or fibers). The visual effect can be met when the physical properties are improved.

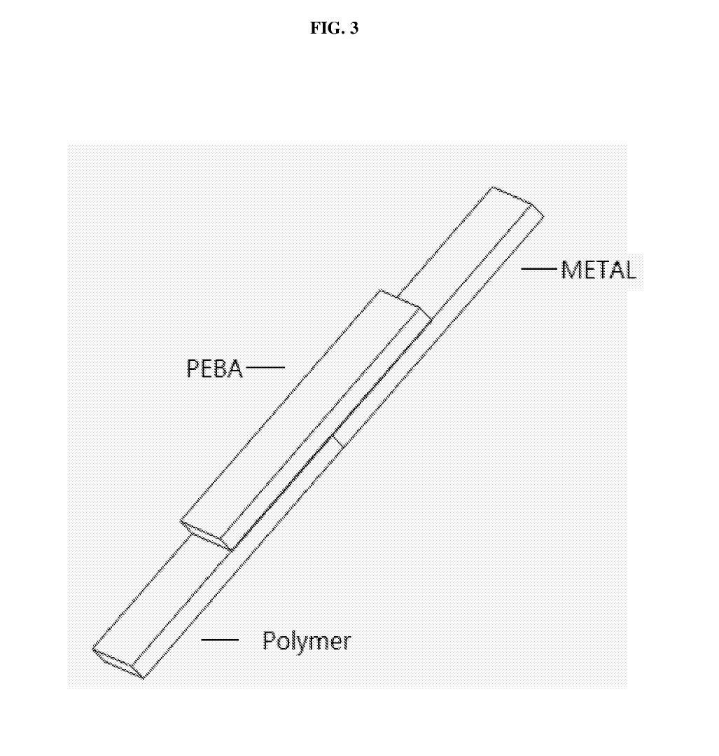

The composite of the present invention can be extended to integrate with polymers other than PEBA as illustrated in FIG. 3

FIG. 3 illustrates an example where metal is integrated with two different polymer, where one of the two is PEBA, according to an embodiment as disclosed herein. In an embodiment, the other polymers can be multi-injected on the PEBA or metal or both. The polymer is different with PEBA. For example, the selection of the polymer and the number of layers may be dependent on the application for which the composite may be used. The polymers can be totally different material with PEBA. They can be hard plastics which is used in insert molding technology such as PPS, PBT and PA etc. Also the PEBA can be modified with some additives or modifiers. For example, flame retardant/UV stable additives can be added in the PEBA. They can improve the flame retardant or UV stable of the PEBA compound. Glass fiber also can be compounded with PEBA to improve the strength. However, the percentage of the additives is limited so as not to impact the bonding force and other properties of the PEBA.

Further, the injection process include all kinds of molding process which can include, but not limited to, injection, extrusion, blowing molding or dip etc.

In an embodiment, the molding process can be single material or multi-material process. In another embodiment, the molding process can be single mold or multi-mold process. For example, single material, multi-material injection mold, or single injection, multi-injection mold process may be implemented to obtain the composite.

In an embodiment, the plastic interlocks with the metallic substrate at the treated area to form the composite with good bonding force. Unlike conventional composites with hard plastics, the composite of the proposed method shows good bonding force, better impact strength, and tightness. Also, the composite of the proposed method, can be used as one or more of flame retardant, impact resistance, seal performance, and reinforcing agent property.

The invention provides a composite which integrates different plastics (elastomer) and metal. The composite have several applications and can be widely used in industries owing to the properties of PEBA.

Following the method mentioned above, different composition PEBA (the specific grade is PEBAX, the elastomer series sold by Arkema, whose number average molar mass is about 700-16000 g/mol) is injected with different process parameter to form different composite test bars. The destructive test is performed on the test bars one by one. The loaded force separating the plastics and metal are recorded in table 1:

sample group 1-1

| | plastics | | | | | | | |
|---|---|---|---|---|---|---|---|---|
| | Elastomer (Arkema 2533), PA wt 10% | | | | | | | |
| | Injection process parameter | | | | | | | |
| | 9.5 MPa | | | | | | | |
| | 100 mg temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 3.1 | 3.3 | 2.8 | 3.1 | 5.6 | 6.1 | 2.7 | 2.9 |
| 60-65° C. | 2.9 | 3 | 5.7 | 6 | 5.8 | 6.3 | 2.6 | 2.7 |
| 50-55° C. | 5.5 | 6.1 | 2.8 | 6.2 | 2.7 | 5.3 | 0.27 | 0.28 |
| 40-45° C. | 0.28 | 0.3 | 0.26 | 0.28 | 0.26 | 2.7 | 0.25 | 0.26 |

sample group 1-2

| | plastics | | | | | | | |
|---|---|---|---|---|---|---|---|---|
| | Elastomer (Arkema 2533), PA wt 10% | | | | | | | |
| | Injection process parameter | | | | | | | |
| | 10.5 MPa | | | | | | | |
| | 100 mg temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 2.9 | 3.2 | 2.6 | 3 | 5.9 | 6.1 | 2.6 | 2.9 |
| 60-65° C. | 2.8 | 3 | 5.7 | 5.9 | 6 | 6.3 | 2.6 | 2.8 |
| 50-55° C. | 5.5 | 5.7 | 2.6 | 5.3 | 2.8 | 5.9 | 0.26 | 0.28 |
| 40-45° C. | 0.3 | 0.35 | 0.26 | 2.6 | 0.27 | 2.8 | 0.25 | 0.23 |

sample group 2-1

| | plastics | | | | | | | |
|---|---|---|---|---|---|---|---|---|
| | Elastomer (Arkema 35R33), PA wt 20% | | | | | | | |
| | Injection process parameter | | | | | | | |
| | 9.5 MPa | | | | | | | |
| | 100 mg temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 3.1 | 3.3 | 2.9 | 3.2 | 2.4 | 2.6 | 2.6 | 2.7 |
| 60-65° C. | 3 | 3.1 | 5.7 | 5.9 | 5.8 | 6.1 | 2.3 | 2.5 |
| 50-55° C. | 5.7 | 5.9 | 2.6 | 5.7 | 2.5 | 5.3 | 0.25 | 0.28 |
| 40-45° C. | 0.28 | 0.3 | 0.26 | 2.2 | 0.29 | 2.1 | 0.25 | 0.26 |

sample group 2-2

| | plastics | | | | | | | |
|---|---|---|---|---|---|---|---|---|
| | Elastomer (Arkema 35R33), PA wt 20% | | | | | | | |
| | Injection process parameter | | | | | | | |
| | 10.5 MPa | | | | | | | |
| | 100 mg temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 3.2 | 3.5 | 3.1 | 3.3 | 2.7 | 2.7 | 2.9 | 3.1 |
| 60-65° C. | 3 | 3.1 | 5.9 | 4.2 | 6.1 | 6.4 | 2.7 | 3 |
| 50-55° C. | 5.7 | 4.2 | 2.5 | 4.2 | 2.5 | 6 | 0.25 | 0.27 |
| 40-45° C. | 0.29 | 3.1 | 0.26 | 2.5 | 0.27 | 2.4 | 0.25 | 0.28 |

sample group 3-1

| | plastics | | | | | | | |
|---|---|---|---|---|---|---|---|---|
| | Elastomer (Arkema 4533), PA wt 30% | | | | | | | |
| | Injection process parameter | | | | | | | |
| | 9.5 MPa | | | | | | | |
| | 100 mg temperature/ injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 2.8 | 3.1 | 6.3 | 6.5 | 6.1 | 6.5 | 2.5 | 2.8 |
| 60-65° C. | 2.6 | 3 | 6 | 6.7 | 6.3 | 6.9 | 2.3 | 2.7 |
| 50-55° C. | 6.1 | 6.4 | 2.6 | 6.4 | 2.9 | 4.2 | 0.21 | 0.23 |
| 40-45° C. | 0.23 | 0.25 | 0.22 | 2.5 | 0.23 | 2.3 | 0.21 | 0.21 |

sample group 3-2

| | plastics | | | | | | | |
|---|---|---|---|---|---|---|---|---|
| | Elastomer (Arkema 4533), PA wt 30% | | | | | | | |
| | Injection process parameter | | | | | | | |
| | 10.5 MPa | | | | | | | |
| | 100 mg temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 3.1 | 3.3 | 6.2 | 6.3 | 6.5 | 6.6 | 2.9 | 3.1 |
| 60-65° C. | 2.9 | 3.1 | 6.3 | 6.5 | 6.6 | 6.8 | 2.7 | 3 |
| 50-55° C. | 5.9 | 6.6 | 2.8 | 6.5 | 5.8 | 6.5 | 0.24 | 0.24 |
| 40-45° C. | 0.26 | 0.26 | 0.26 | 2.7 | 2.5 | 2.9 | 0.25 | 0.23 |

The bonding force is rated at different level based on the separating force and the destroy level of plastics. The result are listed in table 2:

mold temperature/injection temperature

| | | | |
|---|---|---|---|
| 270° C. | 250° C. | 230° C. | 210° C. |

Hydrothermal

sample group 2-1

| | | | | | | | | |
|---|---|---|---|---|---|---|---|---|
| 70-75° C. | B | B | B | B | C | C | B | B |
| 60-65° C. | B | B | C | C | C | C | B | B |
| 50-55° C. | C | C | B | C | B | C | A | A |
| 40-45° C. | A | A | A | B | A | B | A | A |

sample group 2-2

| | | | | | | | | |
|---|---|---|---|---|---|---|---|---|
| 70-75° C. | B | B | B | B | C | C | B | B |
| 60-65° C. | B | B | C | C | C | C | B | B |
| 50-55° C. | C | C | B | C | B | C | A | A |
| 40-45° C. | A | B | A | B | A | B | A | A |

sample group 3-1

| | | | | | | | | |
|---|---|---|---|---|---|---|---|---|
| 70-75° C. | B | B | C | C | C | C | B | B |
| 60-65° C. | B | B | C | C | C | C | B | B |
| 50-55° C. | C | C | B | B | B | B | A | A |
| 40-45° C. | A | A | A | A | A | A | A | A |

sample group 3-2

| | | | | | | | | |
|---|---|---|---|---|---|---|---|---|
| 70-75° C. | B | B | C | C | C | C | B | B |
| 60-65° C. | B | B | C | C | C | C | B | B |
| 50-55° C. | C | C | B | C | C | C | A | A |
| 40-45° C. | A | A | A | B | B | B | A | A |

sample group 4-1

| | | | | | | | | |
|---|---|---|---|---|---|---|---|---|
| 70-75° C. | B | B | B | B | C | C | B | B |
| 60-65° C. | C | C | C | C | C | C | B | B |
| 50-55° C. | C | C | C | C | B | B | A | A |
| 40-45° C. | B | B | A | A | A | A | A | A |

sample group 4-2

| | | | | | | | | |
|---|---|---|---|---|---|---|---|---|
| 70-75° C. | B | B | B | B | C | C | B | B |
| 60-65° C. | C | C | C | C | C | C | B | B |
| 50-55° C. | C | C | C | C | B | B | A | A |
| 40-45° C. | B | B | A | B | A | A | A | A |

Note:
The test bars are tested later than reserved 12 hours to 2 days after being molded.

Hydrothermal treatment: the composites are immersed in 60° C. hot water for 10hours, and further tested after reserved for 12 hours to 2 days.

The rating is based on below rules such as C stands for the elastomer only can be separated from the metal part by strong force with the elastomer destroyed and the elastomer left on metal, B stands for the elastomer will be separated from the metal part by bigger force with/without the elastomer destroyed and no elastomer left on metal, and A stands for the elastomer will be separated from the metal part easily.

The strength and the flame retardant of the composite can be improved if the constituents, such as suitable glass fiber, carbon powder additive etc., are adjusted. The bonding performance and test results are similar as table 1 and table 2.

The following description provides some examples on implementation of the present invention. These examples only serve as embodiments of the present invention, and do not limit the scope of the invention in any manner

### EXAMPLE 1

Pretreatment of the metal: A1100, the commercialized Aluminum sheet whose thickness is 1.5mm, is cut as rectangle (late called Al part) with size of 50 mm*10 mm They are put in a purge tank after polishing. The Al parts is immersed in sodium hydroxide solution at 40 g/L for 2-3 minutes after cleaning by absolute ethyl alcohol. The Al parts are then flushed with deionized water and dried by airing. The Al parts are ready after cleaning and degreasing.

### Metal Surface Etch

The Al parts after cleaning and degreasing are immersed in 20wt % sulfuric acid solution anodizing tank as anode. They are electrolyzed at 20 voltage, 18-20° C. for 10 minutes. The Al parts are further picked up and blow dried. The Al parts are further immersed in 10 wt % sodium carbonate solution (pH=12) at 20° C. for 5-6minutes. The Al parts are picked and cleaned with deionized water by flushing and further baked after the etching process. The etched Al parts are ready and are not to be polluted with greasy dirt or other things

The strength and the flame retardant of the composite can be improved if the constituents, such as suitable glass fiber, carbon powder additive etc., are adjusted.

The bonding performance and test results are similar as tablet and table 2.

### Insert Injection

The metal, Aluminum, is inserted in an injection mold tool. Further, the PEBA let is injected to the injection mold tool under controlled temperature, pressure and tooling temperature. The PEBA flows into the prepared gap through runners. Water maintained at a temperature of 150C is filled to cool the injected parts. The cooling speed is controlled at about 7° C./second to solidify PEBA. The composite is released and the plastics integrate with Al parts tightly.

The composite is designed as FIG. 1 for easier testing. The overlapping area is junction surface.

The testing bars are separated as 2 groups. One group is reserved and another group is immersed in 60° C. hot water for 10hours for further processing.

### EXAMPLE TWO

The selection and pre-treatment of the metal (aluminum alloy) are the same as example one. The elastomer is commercialized Arkema 4533. The composite is manufactured identical to that of example 1. Further, another polymer/PPS whose grade name is TOSO SGX-120 (glass fiber reinforced polyphenylene sulfide, PPS) is injected to cover the other side of the metal in the composite. The composite with different plastic/polymer are integrated with different metal junction surface is obtained, as shown in FIG. 2 Similarly, multi-plastic/polymer is integrated with the metal on different area in same junction surface by multi-injection process as shown in FIG. 3.

### EXAMPLE THREE

The metal is magnesium alloy named as AZ91D, PEBA is the commercialized Arkema 4533. The pre-treatment on the metal can be similar to that of the example one, or may be done by anode oxidation and etched base. The film whose thickness is about 5mm (oxidization film) is found on the surface of the metal when a section of the metal part is observed with metallurgical microscope. The nanopores, whose diameter is 40-60 nm, depth of about 1 um, are found on the surface film with electron microscope. More etching nanopores, whose diameter is 300-1000 nm, depth is 4 um, are also found in the metal surface with electron microscope. They are karst cave like structure and double layer pores can be found.

The composite which is injected as example one is marked as sample 5. The bonding performance test and grade evaluation will be processed as example one. The result is shown in table 3 and table 4.

TABLE 3
Bonding strength for Magnesium and plastic.
sample group 5-1

| | Plastic | | | | | | | |
|---|---|---|---|---|---|---|---|---|
| | Arkema 4533, PA weight persentage = 30% | | | | | | | |
| | injection parameter | | | | | | | |
| | 9.5 MPa | | | | | | | |
| | mold temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 2.8 | 3.1 | 2.3 | 2.7 | 6.1 | 6.5 | 2.5 | 2.9 |
| 60-65° C. | 2.6 | 2.9 | 6 | 6.3 | 6.3 | 6.6 | 2.3 | 2.7 |
| 50-55° C. | 2.1 | 2.3 | 2.6 | 2.8 | 2.9 | 3.1 | 0.21 | 0.24 |
| 40-45° C. | 0.23 | 0.26 | 0.22 | 0.26 | 0.23 | 0.25 | 0.21 | 0.25 |

sample group 5-2

| | Plastic | | | | | | | |
|---|---|---|---|---|---|---|---|---|
| | Arkema 4533, PA weight persentage = 30% | | | | | | | |
| | injection parameter | | | | | | | |
| | 10.5 MPa | | | | | | | |
| | mold temperature/injection | | | | | | | |
| | 270° C. | | 250° C. | | 230° C. | | 210° C. | |
| | | Hy- | | Hy- | | Hy- | | Hy- |
| | | dro- | | dro- | | dro- | | dro- |
| | | ther- | | ther- | | ther- | | ther- |
| | | mal | | mal | | mal | | mal |
| 70-75° C. | 3.1 | 3.3 | 2.5 | 2.7 | 6.5 | 6.6 | 2.8 | 3.1 |
| 60-65° C. | 3 | 3.1 | 6.7 | 6.5 | 6.9 | 6.8 | 2.7 | 3 |
| 50-55° C. | 2.2 | 2.3 | 2.8 | 6.5 | 3 | 3.5 | 0.23 | 0.24 |
| 40-45° C. | 0.26 | 0.26 | 0.25 | 2.7 | 0.25 | 0.29 | 0.21 | 0.23 |

TABLE 4
Bonding performance grade evaluation for magnesium and plastic.

| mold temperature/injection | | | |
|---|---|---|---|
| 270° C. | 250° C. | 230° C. | 210° C. |

| | | | |
|---|---|---|---|
| Hy- | Hy- | Hy- | Hy- |
| dro- | dro- | dro- | dro- |
| ther- | ther- | ther- | ther- |
| mal | mal | mal | mal |

sample group 5-1

| | | | | | | | | |
|---|---|---|---|---|---|---|---|---|
| 70-75° C. | B | B | B | B | C | C | B | B |
| 60-65° C. | B | B | C | C | C | C | B | B |
| 50-55° C. | B | B | B | B | B | B | A | A |
| 40-45° C. | A | A | A | A | A | A | A | A |

sample group 5-1

| | | | | | | | | |
|---|---|---|---|---|---|---|---|---|
| 70-75° C. | B | B | B | B | C | C | B | B |
| 60-65° C. | B | B | C | C | C | C | B | B |
| 50-55° C. | C | C | B | C | B | B | A | A |
| 40-45° C. | A | A | A | B | A | A | A | A |

The foregoing description of the specific embodiments will so fully reveal the general nature of the embodiments herein that others can, by applying current knowledge, readily modify and/or adapted for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A composite comprising: a plastic interlocked to a surface of a metallic substrate to form the composite, wherein the plastic is composed of at least one layer of a Polyether Block Amide (PEBA).

2. The composite as claimed in claim 1, wherein the metallic substrate includes one of a single element metal and an alloy.

3. The composite as claimed in claim 2, wherein the single element metal is one of an aluminum, magnesium, titanium, copper, and stainless steel.

4. The composite as claimed in claim 1, wherein at least a portion of the metallic substrate is chemically treated to obtain a nano-porous structure.

5. The composite as claimed in claim 4, wherein the nano-porous structure comprises pores having a diameter in a range of 10 to 2000 nanometers (nm).

6. The composite as claimed in claim 4, wherein the nanoporous structure is obtained by anodic oxidation.

7. The composite as claimed in claim 1, wherein the PEBA is a copolymer of an amide and an ether, wherein the amide has a weight percentage of at least 10%, more preferably in a range of 30% to 90%.

8. The composite as claimed in claim 1, wherein the PEBA is of a molecular weight ranging from 500-20000 g/mol.

9. The composite as claimed in claim 1, wherein the composite has one or more of flame retardant, impact resistance, seal performance and reinforcing agent property.

10. A process for preparing a composite, the process comprising:
treating a surface of a metallic substrate, wherein the metallic substrate includes a single element metal or an alloy, to obtain a nanoporous structure; and
interlocking the nanoporous structure with a plastic, wherein the plastic is composed of at least one layer of Polyether Block Amide (PEBA) to obtain the composite.

11. The process as claimed in claim 10, wherein the interlocking is performed by injecting, at least once, the plastic into the nanoporous structure under optimum conditions.

12. The process as claimed in claimed in claim 10, wherein the optimum conditions include an injection temperature in a range of 210-270° C., injection pressure in an range of range of 8 to 11 MPa, mold temperature in a range of range of 40-80° C., and a cooling speed being controlled at a rate of 6-8° C./second.

13. The process as claimed in claim 10, comprises immersing the composite in water at a temperature range of 40-80° C. for 8-12 hours.

14. The process as claimed in claim 10, wherein the nanoporous structure comprises of pores having a diameter in a range of 10 to 2000 nanometers (nm).

15. The process as claimed in claim 10, wherein the nanoporous structure is obtained by anodic oxidation.

16. The process as claimed in claim 10, wherein the PEBA is a copolymer of an amide and an ether, wherein the amide has a weight percentage of at least 10%, more preferably in a range of 30% to 90%.

17. The process as claimed in claim 10, wherein the PEBA is of a molecular weight ranging from 500-20000 g/mol.
